(19) United States
(12) Patent Application Publication
(10) Pub. No.: US 2008/0146289 A1
(43) Pub. Date: Jun. 19, 2008

(54) AUTOMATIC AUDIO TRANSDUCER ADJUSTMENTS BASED UPON ORIENTATION OF A MOBILE COMMUNICATION DEVICE

(75) Inventors: JOSE E. KORNELUK, LAKE WORTH, FL (US); JESUS F. CORRETJER, WESTON, FL (US); EDWARD L. GILMORE, SUNRISE, FL (US); LUIS A. PICHARDO, MIRAMAR, FL (US); ELLIS A. PINDER, DAVIE, FL (US)

Correspondence Address: PATENTS ON DEMAND, P.A., 4581 WESTON ROAD, SUITE 345, WESTON, FL, 33331, US

(73) Assignee: MOTOROLA, INC., SCHAUMBURG, IL (US)

(21) Appl. No.: 11/610,974

(22) Filed: Dec. 14, 2006

(51) Int. Cl. H04M 1/00

(52) U.S. Cl. 455/569.1

(57) ABSTRACT

A solution for automatically activating different audio transducers of a mobile communication device based upon an orientation of the device. In the solution, a series of speaker/microphone assemblies can be positioned on the device, such as positioned near an earpiece and positioned near a mouthpiece. Different speaker/microphone assemblies can also be positioned on the front of the device and on the back of the device. The solution can automatically determine an orientation for the device, based upon a detected direction of a speech emitting source and/or based upon one or more sensors, such as a tilt sensor and an accelerometer. For example, when a device is in an upside down orientation, an earpiece microphone and a mouthpiece speaker can be activated. In another example, an otherwise deactivated rear facing speaker can be activated when the device is oriented in a rear facing orientation.

### BACKGROUND

1. Field of the Invention

The present invention relates to mobile communication devices and, more particularly, to automatic audio transducer adjustments based upon orientation of a mobile communication device.

2. Description of the Related Art

Capabilities of mobile communication devices exceed capabilities of desktop computing systems of decades past. These devices are used for numerous purposes including, but not limited to, mobile telephony, emailing, text messaging, contact management, entertainment and electronic gaming, Web browsing, and the like. Being relatively small devices having varied capabilities, different uses often dictate different shapes and arrangements of controls.

For example, when used extensively for text messaging, a mobile communication device provides a text input mechanism (e.g., a keypad) and a display screen for user utilization. When used for visual media purposes, such as picture and video presentation, a display screen of the mobile device needs to be displayed in a manner convenient to a user, possibly with rotatable viewing options for portrait or landscape viewing. When used for gaming purposes, a display and directional controls need to be conveniently presented.

The different device orientations have resulted in multiple and often redundant audio transducers being positioned upon the mobile device. For example, a traditional microphone can be included in an earpiece and a speaker can be positioned in an opposing position, when used for mobile telephony or dispatch purposes. A different speaker/microphone combination can be positioned on an opposing side of the device, possibly for use in a hands-free or speakerphone mode when a clam-shell shaped mobile device is in a closed position. Other audio transducers can be optimally positioned for use with speech-enabled applications on mobile communication devices having personal data assistant (PDA) like capabilities.

A similar configuration problem exists for any dual sided communication device. For example, a two way radio can have a different speaker-microphone assembly on each side (e.g., a front side and a back side). One side can have a high powered speaker and can have an intended normal use for voice communications. The other side can have a low power speaker, a large display, and an intended normal use for data and text based communication. In such a two way radio, a user will flip from front to back, depending on intended use. Flipping can require a change in audio transducer configuration and similar setting changes for other components (i.e., backlighting display when data side is facing user and disabling backlighting otherwise).

### SUMMARY OF THE INVENTION

A solution for automatically activating different audio transducers of a mobile communication device based upon an orientation of the device. In the solution, a series of speaker/microphone assemblies can be positioned on the device, such as positioned near an earpiece and positioned near a mouthpiece. Different speaker/microphone assemblies can also be positioned on the front of the device and on the back of the device. The solution can automatically determine an orientation for the device, based upon a detected direction of a speech emitting source and/or based upon one or more sensors, such as a tilt sensor and an accelerometer.

Orientations can include, for example, right side-up, upside-down, sideways, forward-facing, rearward facing, and the like. Different speaker/microphone activation configurations can be associated with the different orientations. For example, if a device is oriented upside-down, typical speaker/microphone positions can be reversed by toggling activation states of speakers and microphones earpiece/mouthpiece assemblies. In another example, if a device is rearward facing, one or more forward facing audio transducers can be deactivated. Deactivating unnecessary audio transducers conserves power, thereby extending a battery life of a mobile communication device. In one embodiment, additional interface controls and elements, such as a display, can be selectively configured in a fashion suitable for a determined orientation when the audio transducers are configured. In another configuration, the solution can also provide a manual override option or an orientation detection disablement option, so that when a device is used in a non-standard fashion, such as talking on a mobile phone while in a horizontal position or while hanging upside down, automatic orientation capabilities do not degrade a user's experience.

The present invention can be implemented in accordance with numerous aspects consistent with the material presented herein. One aspect of the present invention can include a method for automatically configuring audio transducers of a mobile device. The method can include a step of automatically ascertaining an orientation of a mobile device. A previously stored configuration associated with the ascertained orientation can be detected. An activation state of at least one audio transducer of the mobile device can be changed in accordance with the determined configuration.

Another aspect of the present invention includes a mobile device that includes a plurality of audio transducers, a device memory, and an orientation detector. The device memory can store a plurality of orientation states and related configurations. Each configuration can specify which of the audio transducers are activated and which are deactivated. The orientation detector can automatically detect an orientation of the device, which results in an activation state of the audio transducers being dynamically and automatically altered in accordance with a stored configuration associated with the detected orientation.

Still another aspect of the present invention can include a mobile communication device having a plurality of audio transducers positioned in various different positions of the mobile communications device. The device can also include an orientation detection mechanism configured to automatically determine an orientation of the mobile communication device. Further, the device can include a configuration control mechanism configured to selectively and automatically activate particular ones of the audio transducers depending upon the determined orientation of the mobile device.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

The method detailed herein can also be a method performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system of a mobile communication device having multiple audio transducers that are automatically adjusted based upon orientation.

FIG. 2 is a schematic diagram of a mobile communication device having orientation adjustment capabilities for included audio transducers in accordance with an aspect of the inventive arrangements disclosed herein.

FIG. 3 is a schematic diagram of a mobile communication device (e.g., a two way radio) having front-back orientation adjustment capabilities for included audio transducers in accordance with an aspect of the inventive arrangements disclosed herein.

FIG. 4 is a schematic diagram of a mobile communication device that automatically configures audio transducers based upon orientation.

FIG. 5 is a flow chart of a method for dynamically configuring audio transducers based upon an orientation of a mobile device.

FIG. 6 is a flow chart of a method for dynamically configuring audio transducers based upon an orientation of a mobile device.

FIG. 7 is a flow chart of a method for dynamically configuring audio transducers for a front-back facing mobile device (e.g., two way radio) having simplex communication modes.

### DETAILED DESCRIPTION OF THE INVENTION

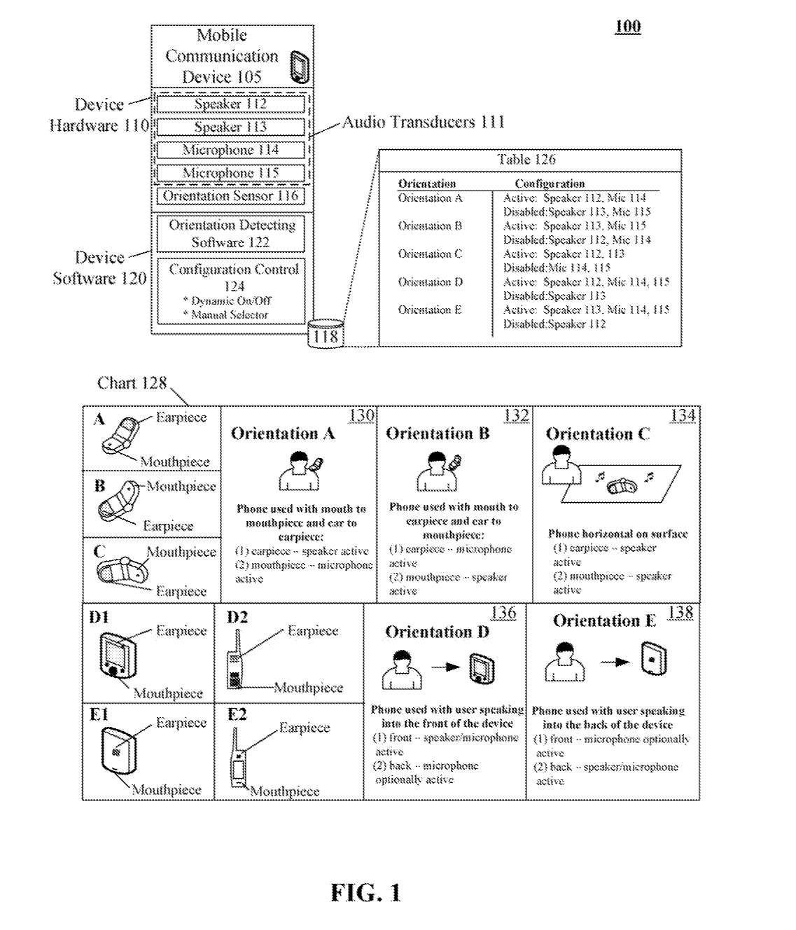

FIG. 1 is a schematic diagram of a system 100 of a mobile communication device 105 having multiple audio transducers 111 that are automatically adjusted based upon orientation. Device 105 can include, but is not limited to, a mobile telephone, a two way radio, a notebook computer, a tablet computer, a wearable computer, an embedded computer, a mobile email appliance, a media player, an entertainment system, and the like.

The audio transducers 111 in device 105 can include multiple speakers 112-113 and multiple microphones 114-115 positioned in different locations of a handset or flip assembly. Hardware of the mobile communication device 110 can also include an optional orientation sensor 116. The sensor 116 can be a tilt sensor, an accelerometer, or other orientation detection mechanism.

The device software 120 can include orientation detection software 122 and/or a configuration controller 124. The orientation detection software 122 can determine an orientation of device 105 based upon input from orientation sensor 116 and/or based upon a direction from which speech input is received. In various implementations, the orientation detection software 122 can dynamically and automatically determine orientation from input from sensor 116 alone, voice input received by multiple microphones 114-115 alone, or from both types of input used in combination. An orientation of device 105 can be determined from a relative plane based upon gravity and/or based upon a relative position of device 105 compared to a relative position of a device user.

In one arrangement, the orientation detection software 122 can detect a presence and/or strength of a human voice at one of the microphones 114-115. A relative orientation of the user can be determined by comparing audio energy levels received by microphones 114-115. Filtering and audio processing techniques, similar to those used for noise cancellation purposes, can result in an accurate determination. Further, in one embodiment, a Voice Activity Detection (VAD) algorithm can be used by the orientation detection software 122.

The configuration controller 124 can include a user selectable on/off switch to change an enablement state of the automatic orientation detection software 122. Further the configuration controller 124 can include manual selectors (i.e., buttons or graphical user interface “GUI” controls) that permit a user to manually select a configuration. Manual configuration adjustments can override dynamically determined adjustments. It should be emphasized that having extraneous audio transducers 111 active can represent a power drain, which can shorten battery life of device 105. Therefore, configuration controller 124 ideally can dynamically adjust audio transducer 112-115 settings so that only necessary audio transducers 111 are active at any time.

The configuration controller 124 can use table 126 to automatically adjust configuration specific settings based upon an automatically determined orientation Table 126 which can be stored in the data store 118 and can relate a set of orientation values to a corresponding set of configuration files. Table 126 includes configuration files for Orientations A-C and Orientations D1, D2, E1 and E2, which are collectively referenced as Orientations A-E. These orientations and corresponding configuration settings are presented for illustrative purposes and the invention is not to be limited in this regard. The orientations of table 126 and their associated configurations are demonstrated in chart 128, which pictorially illustrates the Orientations A-E. The left side of chart 128 shows a relative position of an earpiece to a mouthpiece of a mobile device in each of the orientations. The earpiece and the mouthpiece can both include a speaker/microphone assembly for Orientations A-C. In Orientations D1, D2, E1, and E2, a single device can have a front facing speaker/microphone assembly and a different rear facing speaker/microphone assembly. Orientation D1 and E1 can represent a configuration where the mobile communication device 105 is implemented as a PDA or mobile telephone. Orientation D2 and E2 can represent a configuration where the mobile communication device 105 is implemented as a two way radio.

Picture 130 shows an Orientation A that illustrates a phone being used by a user where the user's mouth is proximate to the device's mouthpiece. In other words, Orientation A can represent a basic, correct use of mobile device 105. In Orientation A, a speaker in the earpiece and a microphone in the mouthpiece can be active while a microphone in the earpiece and a speaker in the mouthpiece can be deactivated. In embodiments where device 105 performs noise filtering operations or where device 105 detects a user position by comparing inputs received from multiple sources, the device 105 can keep the microphone in the earpiece active (assuming Orientation A). Other Orientations B-E can also keep additional microphones active for noise cancellation/speaker detection purposes.

Picture 132 shows an Orientation B that illustrates a phone being used by a user having their mouth proximate to the device's earpiece. That is, Orientation B can represent a situation where a user positions the device 105 in an upside-down position. In Orientation B, a speaker in the earpiece and a microphone in the mouthpiece can be activated while a microphone in the earpiece and a speaker in the mouthpiece can be activated.

Picture 134 shows an Orientation C that illustrates a phone positioned in an approximately horizontal position. In this position, the device 105 can be used to play stereo audio. That is, assuming device 105 functions as an MP3 or digital audio player, songs and other audio can be played in stereo when the device 105 is horizontal. In Orientation C, the speakers in both the earpiece and mouthpiece can be activated, where microphones can be deactivated.

Picture 136 shows an Orientation D (e.g., D1 and/or D2) that illustrates a device (e.g., a phone or two way radio) being used by a user speaking into the front of the device. In Orientation D, a front speaker/microphone can be activated while a back speaker can be deactivated. The back microphone can be optionally kept active in order to perform user detection and noise cancellation operations. In embodiments where the mobile device includes a large display, the display can be backlit when the display is facing a user and disabled when the display facing away from the user. Notably, disabling/deactivating unnecessary components, such as unnecessary speakers or backlighting, can save battery power.

Picture 138 shows an Orientation E (e.g., E1 and/or E2) that illustrates a mobile device being used by a user speaking into the back of the device. In Orientation E, a back speaker/microphone can be activated while a front speaker can be deactivated. The front microphone can be optionally kept active.

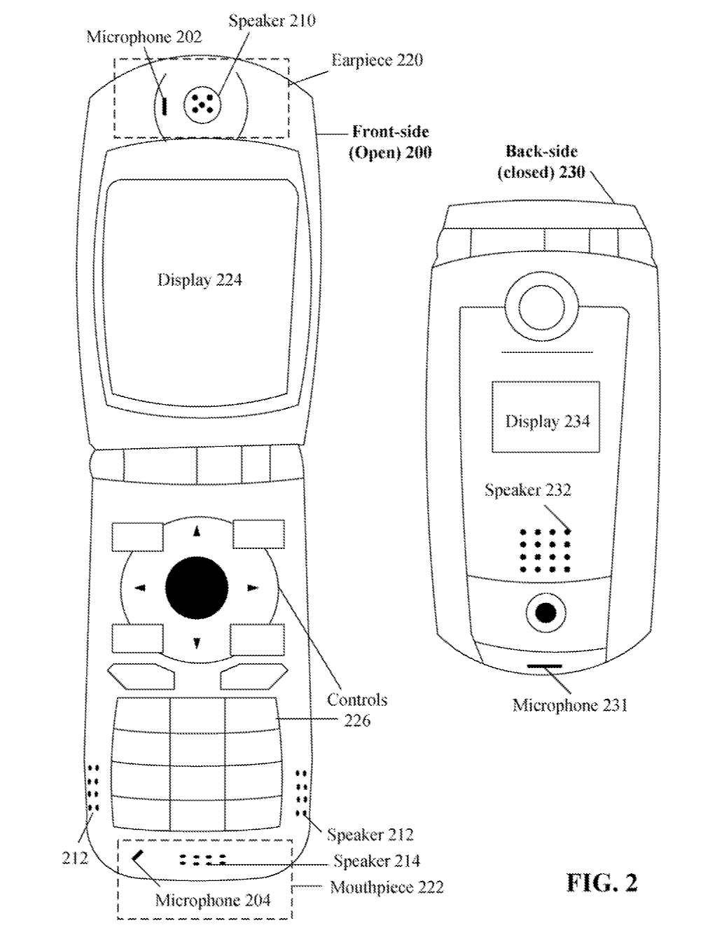

FIG. 2 is a schematic diagram of a mobile communication device having orientation adjustment capabilities for included audio transducers in accordance with an aspect of the inventive arrangements disclosed herein. Although in FIG. 2 the mobile communication device is illustrated as a clam-shell style mobile telephone, the invention can be implemented within any configuration and is not limited to a clam-shell style device.

When the device front is open 200, an earpiece 220 and a mouthpiece 222 can be accessed. The earpiece 220 can include a speaker 210 and a microphone 202. Similarly the mouthpiece 222 can include a microphone 204 and speaker 214. Optional side speakers 212 can also be included. One or more controls 226 can receive user input. The device can also include display 224. In one embodiment, a display orientation 224 can automatically adjust as the audio transducers are adjusted. For example, in Orientation A 130 images presented upon display 224 can be presented from top-to-bottom; in Orientation B 132 images presented upon display 224 can be rotated 180 degrees; and, in Orientation C 134 images presented upon display 224 can be rotated 90 or 270 degrees, as determined from a reference plane based upon gravity or based upon a user position as inferred by a voice input direction.

The backside 230 of the closed device shows another speaker 232 and microphone 231 as well as a back-side display 234. As previously illustrated in pictures 130-138, front-side audio transducers (202, 204, 210, 212, 214) and back-side audio transducers (231, 232) can be dynamically configured based upon device orientation. Further, display 234 and/or 224 can be dynamically activated and deactivated depending upon a determined orientation of the device.

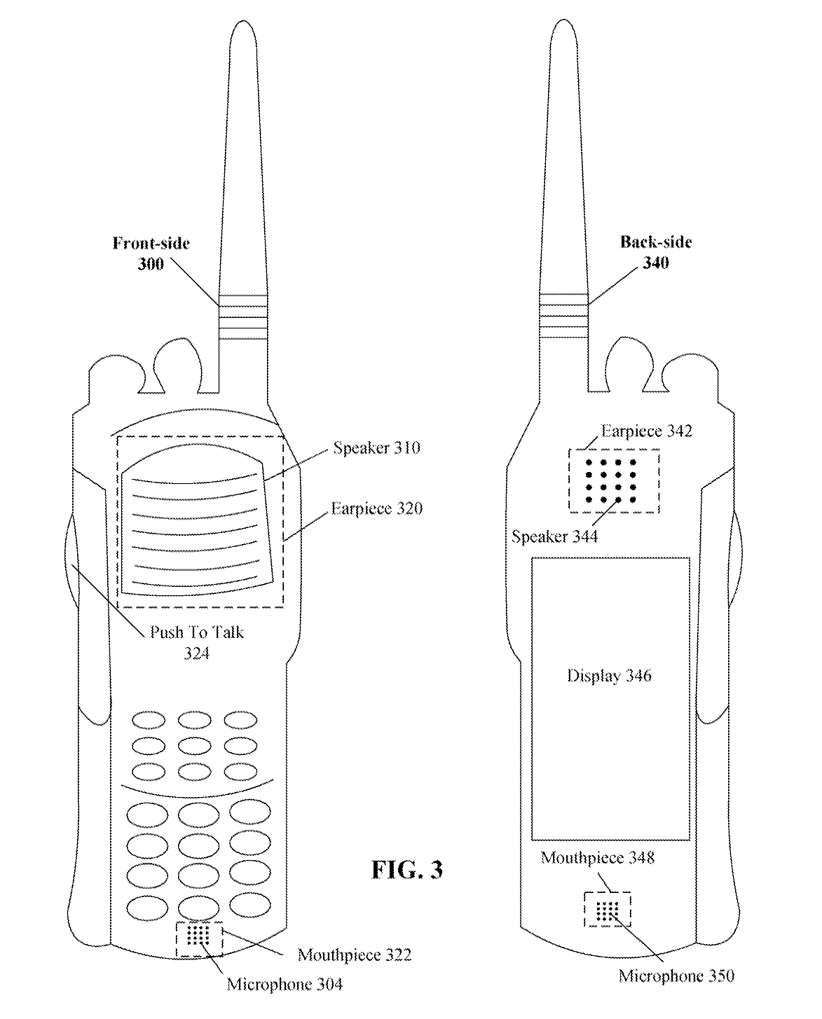

FIG. 3 is a schematic diagram of a mobile communication device (e.g., a two way radio) having front-back orientation adjustment capabilities for included audio transducers in accordance with an aspect of the inventive arrangements disclosed herein. The mobile communication device can be a two way radio or a mobile telephony device having dispatch functionality. Two way radio communications are typically simplex communications, which have ramifications to orientation detection abilities and audio transducer configuration states of the mobile communication device.

The front-side 300 of the communication device can be configured for voice based communication. As such, an earpiece 320 can include a high power speaker 310 and the mouthpiece 322 can include a microphone 304.

The backside 340 of the device can be configured for data and/or text based communication. The earpiece 342 can have a low power speaker 344. The backside 340 can also include a mouthpiece 348 with a microphone 350. A large display 346 can be included that presents text/data. In one embodiment, the display can include a touch screen for data entry and selection purposes. The mobile device can also have speech processing capability, so user provided speech can be automatically speech-to-text converted where the text is displayed within display 346.

Touching a side-facing control can cause that side to be preferred over its opposite. For example, touching a button on side 300 can indicate that the front 300 of the device is facing a user. Similarly, using a touch screen (346) can indicate that the back 340 of the device is user facing. Directional voice input can also be used to determine which side 300 or 340 is facing a user. Components associated with an active side can be enabled, while unnecessary components on an opposing side can be disabled to conserve power. For example, backlighting for the display 346 can be active only when the back-side 340 is active.

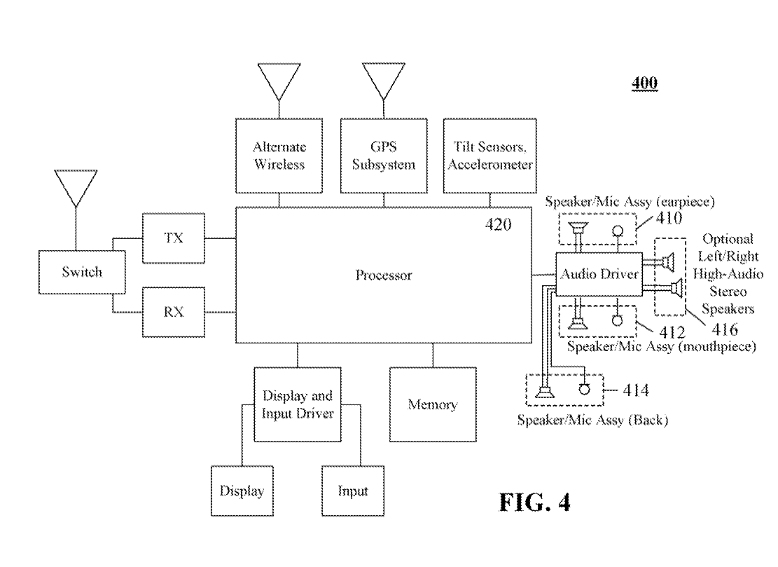

FIG. 4 is a schematic diagram of a mobile communication device 400 that automatically configures audio transducers based upon orientation. Device 400 can represent one implementation of device 105 shown in system 100.

Device 400 can include multiple speaker/microphone assemblies 410-416, which are linked to audio drivers. The audio drivers can be controlled by a processor 420. Other components, such as a wireless component, a GPS subsystem, a tilt sensor, an accelerometer, a memory, a display, and/or input controls can also be linked to processor 420. The memory can include software and/or firmware, such as software 120 shown in system 100.

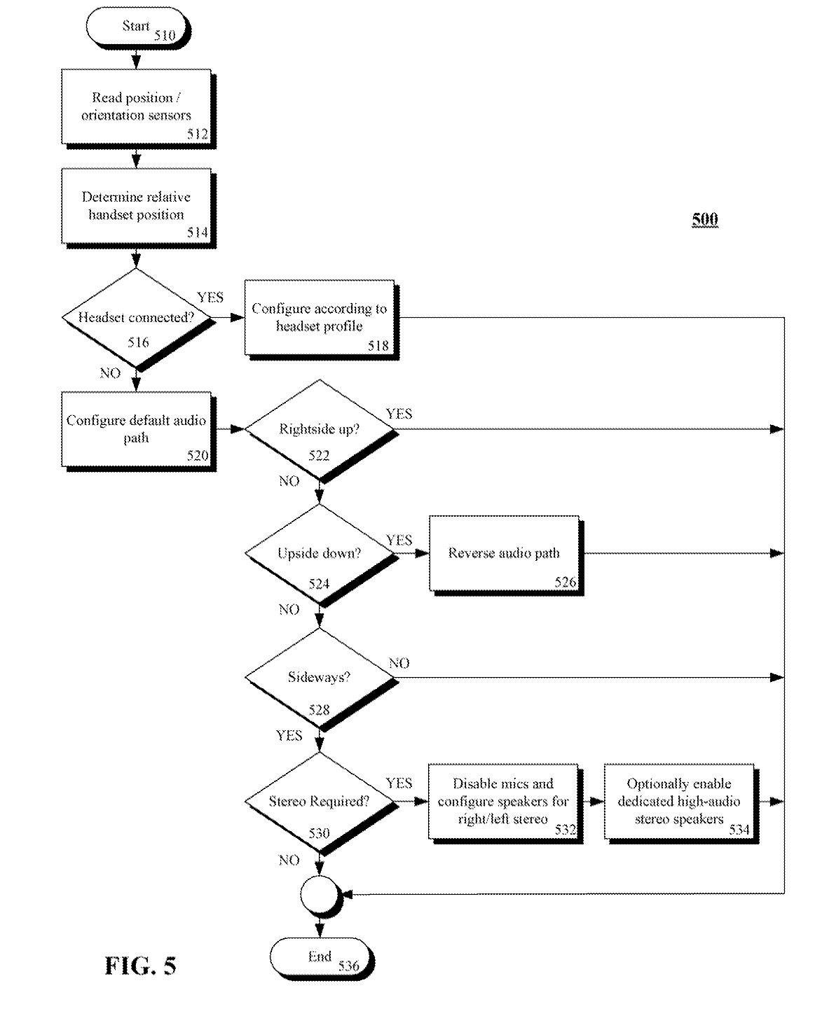

FIG. 5 is a flow chart of a method 500 for dynamically configuring audio transducers based upon an orientation of a mobile device. Method 500 can be performed in the context of a system 100. Specifically, method 500 focuses on situations depicted as Orientations A-C described in system 100.

Method 500 can start 510 in step 512, where orientation sensors of a mobile communication device can be read. When no orientation sensors (e.g., a tilt sensor or accelerometer) are included, input received by multiple microphones can be used to determine a relative position of the mobile communication device. After the input is gathered, a relative position of a handset of the mobile device can be determined 514. Relative position can be determined from a reference plane based upon gravity or based upon a user position as inferred by a voice input direction.

In step 516, the method can check to see whether a headset is connected to the communication device. If so, the method can proceed from step 516 to step 518 where the device can be configured in accordance with a headset profile. The method can then end 536.

When a headset is not connected in step 516, the method can proceed to step 520, where a default audio path can be configured. In step 522, the method can check whether the device is right-side-up. If so, the method can be in a “default audio state” that causes the method to proceed from step 522 to step 536. If not right-side-up, the method can proceed to step 524, where a determination can be made regarding whether the device is upside down. When the device is upside-down, audio pathways can be reversed in step 526. For example, a mouthpiece can activate a speaker instead of a microphone and an earpiece can activate a microphone instead of a speaker. The method can thereafter end 536.

When the device is not upside down, the method can proceed from step 524 to step 528, where a determination as to whether the device is sideways or not can be made. If not sideways (e.g., relatively horizontal or approximately perpendicular to gravity), then the method can end 536. When the device is sideways, the method can proceed from step 528 to step 530, where a determination whether stereo output is required can be made. If stereo output is not determined, the method can end in step 536. If stereo output is determined, the method can proceed from step 530 to step 532, where microphones can be disabled and earpiece/mouthpiece speakers can be configured for left/right stereo. In optional step 534, dedicated high-audio stereo speakers can be enabled. After step 534, the method can end 536.

Even after the method ends 536, it can be automatically started 510 again based upon an occurrence of detectable events, such as a headset being disconnected, the device being repositioned, a flip assembly being opened/closed, and the like.

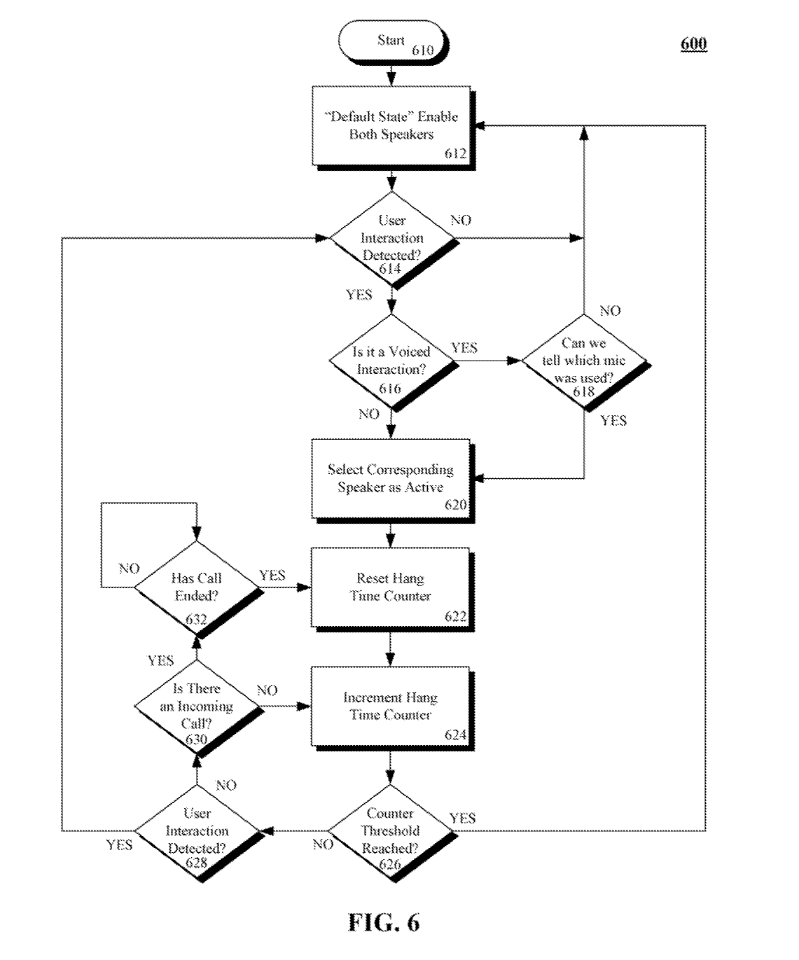

FIG. 6 is a flow chart of a method 600 for dynamically configuring audio transducers based upon an orientation of a mobile device. Method 600 can be performed in the context of a system 100. Specifically, method 600 focuses on situations involving Orientations D-E described in system 100.

The method 600 uses a knowledge of which side a dual-sided device is being used as well as a hang time counter and corresponding threshold to dynamically select one of the speakers present on each side of a device. A side of use can be detected based upon an interaction, such as a button press (e.g., keypad, touch screen input, and the like) or by detecting a presence of voice input direction.

At startup 610, the device can go into a default state 612 of operation where both speakers are simultaneously activated to ensure no received calls or portions thereof are missed. This can be done in the interest of maintaining reliable communications. While in the default state 612, audio for incoming calls can be presented on both front facing and rear facing speakers. This state can be maintained until a user interaction 614 is detected, which is indicative of which side of a device a user is utilizing. Upon detecting a used side, software of the device can select one or more speaker 620 on that side to be used. A speaker on an opposing side can be disabled. This selected speaker can be utilized for device activity (such as announcing incoming calls) until either a hang time expires (steps 622-626) or another user interaction 628 is detected. If an incoming call or similar interaction is received (630-632) before the hang time threshold is reached, the hang time counter can be suspended (looping step 632). When the call ends (steps 632-622) the hang time counter can be reset. Before this, the selected speaker remains active and speakers on the opposing side of the device remain disabled.

If while waiting on the hang time to expire, another user interaction is detected 628, the method can proceed to determine which side of the radio is being used (steps 628 to step 614). A corresponding speaker (step 620) can be selected for the side that is used. Whenever the hang time threshold is reached 626, the method can return to a default state (step 612).

During voice based interactions (step 616), there is a chance that due to high background noise, cross-talk, or other conditions, the device can be unable to determine which microphone (front or rear) is being used. In such a situation, the method can loop from step 618 to step 612, where the device can revert to a default state of enabling both speakers.

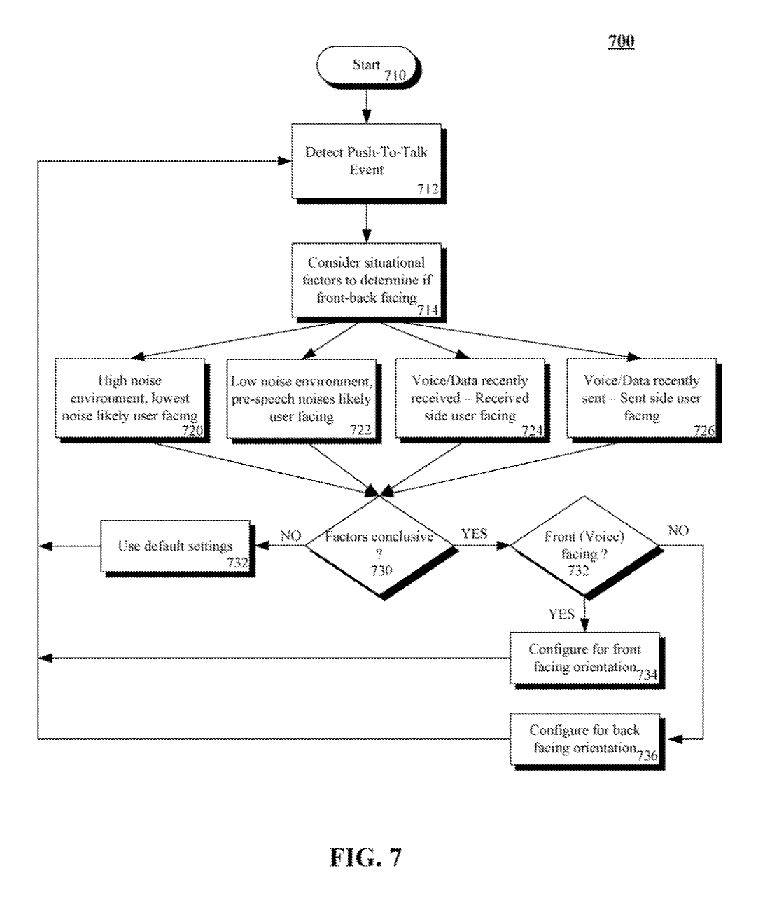

FIG. 7 is a flow chart of a method for dynamically configuring audio transducers for a front-back facing mobile device (e.g., two way radio) having simplex communication modes. Method 700 can be performed in the context of a system 100. Specifically, method 700 focuses on situations involving Orientations D-E described in system 100 and a use of a transceiver configurable device during a push-to-talk communication, which is a simplex communication.

Method 700 can start 710 by detecting a push-to-talk event 712. This event can cause a processor to evaluate situation factors to determine if the device is front or back facing. Any number of factors can be used, such as factors shown in steps 720-726.

For instance step 720 can be used when a device is used in a high noise environment. There, it is likely that a lowest amount of noise is in a user facing direction. Step 722 can be used in a low noise environment where pre-speech noises (e.g., breathing, throat clearing, and the like) can be detected from a user's direction. In step 724, if voice/data has been recently received from one direction, then a side associated with the received content is likely user-facing. That is, if data has been recently received, a data side is likely to be user facing. If a voice communication has recently been received, a voice side is likely to be user facing. Step 726 is similar in that a side (voice or data) corresponding to type of recently conveyed data can be used to determine a side that is user facing.

The factors 720-726 are illustrative factors that are not intended to be exhaustive and other factors can be utilized. For example, if a button associated with one side or another is pressed in addition to having the push-to-talk button pressed, then the side associated with the button is likely to be user facing. Also, if a device has two push-to-talk buttons then an active side can depend upon which button is pushed and whether a user is right or left handed.

After the factors 720-726 are determined, they can be processed, which may require applying varying weights to different factors to determine whether a user facing side can be determined conclusively 730. It should be appreciated that different detectable events, such as motion detection by an accelerometer that can indicate that the device is turned, can result in the confidence level varying or can result in different factors 720-726 having increased or decreased weights.

If the factors are not conclusive, the method can process from step 730 to step 732 where default settings can be used. The default settings 732 can, for example, activate audio transceivers on both sides of the device, which can ensure that communications are clear, yet which can be power draining. The method can loop from step 732 back to step 712 where a new push-to-talk event can be detected.

When the factors are conclusive, then a separate determination can be made 732 as to which side is user facing. When the device is front facing, the method can proceed to step 734 where the device can be configured for a front facing orientation 734. When the device is back facing, as shown by step 736, the device can be configured for a back facing configuration. Side specific backlighting, side specific audio transducers, and other side specific controls can all be dynamically and automatically adjusted depending upon which side is user facing. After either step 734 or step 736, the method can loop to step 712 where another push-to-talk event can be detected.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

1. A method for automatically configuring audio transducers of a mobile device comprising:
automatically ascertaining an orientation of a mobile device;
determining a previously stored configuration associated with the ascertained orientation; and
changing an activation state of at least one audio transducer of the mobile device in accordance with the ascertained configuration.

2. The method of claim 1, wherein the ascertained orientation state is selected from a group of states comprising a right-side-up state and an upside-down state, said method further comprising:
identifying a speaker/microphone assembly associated with each of an earpiece and a mouthpiece; and
toggling activation states of the speaker/microphone assembly so that an upward facing assembly has a speaker activated and a microphone deactivated and so that a downward facing assembly has a speaker deactivated and a microphone activated.

3. The method of claim 2, wherein the ascertaining step uses at least one of an accelerometer and a tilt sensor.

4. The method of claim 1, wherein the determined orientation state is a sideways state, wherein the changing state further comprises:
determining two speakers that are included within speaker/microphone assemblies that are horizontally opposed;
activating the two speakers; and
establishing one of the two speakers as a right channel speaker and the other as a left channel speaker for purposes of producing stereo output.

5. The method of claim 4, wherein the ascertaining step is determined using at least one of an accelerometer and a tilt sensor.

6. The method of claim 1, wherein the determined orientation state is selected from a group of states comprising a forward-facing state and a rearward-facing state, said ascertaining step further comprising:
detecting incoming speech; and
determining the orientation state based upon a direction from which the incoming speech was produced.

7. The method of claim 6, further comprising:
automatically enabling speakers on a side of the mobile device corresponding to the orientation state; and
automatically disabling at least one speaker on a side of the mobile device opposite to the orientation state.

8. A mobile device comprising:
a plurality of audio transducers;
a device memory configured to store a plurality of orientation states and related configurations, each configuration specifying which of the audio transducers are activated and which are deactivated; and
an orientation detector that automatically detects an orientation of the device, which results in an activation state of the audio transducers being dynamically and automatically altered in accordance with a stored configuration associated with the detected orientation.

9. The mobile device of claim 8, wherein the plurality of audio transducers include at least two speaker/microphone assemblies, one corresponding to an earpiece and another to a mouthpiece, wherein the orientation states include a right-side-up state and an upside-down state, wherein the configuration file corresponding to the right-side-up state activates an earpiece speaker and a mouthpiece microphone and deactivates a mouthpiece microphone and an earpiece speaker, and wherein the configuration file corresponding to the upside-down state deactivates an earpiece speaker and a mouthpiece microphone and actives a mouthpiece microphone and an earpiece speaker.

10. The mobile device of claim 8, wherein the plurality of audio transducers include at least one front facing speaker and microphone and at least one rear facing speaker and microphone, wherein the orientation states include a forward-facing state and a rearward-facing state, and wherein configuration files specify that speakers on a same side as the orientation state are activated and that speakers on an opposing side are deactivated.

11. A mobile communication device comprising:
a plurality of audio transducers positioned in various different positions of a mobile communications device;
an orientation detection mechanism configured to automatically determine an orientation of the mobile communication device; and
a configuration control mechanism configured to selectively and automatically activate particular ones of the audio transducers depending upon the determined orientation.

12. The device of claim 11, wherein the orientation detection mechanism is configured to determine a position of the mobile communication device relative to a direction of gravity.

13. The device of claim 11, wherein the orientation detection mechanism is configured to determine a position of the mobile device relative to a direction from which user speech originates.

14. The device of claim 11, wherein the orientation detection mechanism includes at least one of an accelerometer and a tilt sensor.

15. The device of claim 11, wherein the orientation detection mechanism utilizes a voice activity detection algorithm to determine an orientation of the mobile communication device relative to a user.

16. The device of claim 11, further comprising a data store including information for a plurality of different device orientations, each device orientation being associated with an orientation specific configuration, each configuration specifying a set of the audio transducers that are to be automatically activated by the configuration control mechanism and a set of the audio transducers that are to be automatically deactivated by the configuration control mechanism.

17. The device of claim 11, further comprising:
a user selector for changing an enablement state of a dynamic orientation capability of the device depending upon user provided input.

18. The device of claim 11, wherein the plurality of audio transducers includes a first speaker/microphone assembly positioned proximate to an earpiece section of the mobile communication device and includes a second speaker/microphone assembly positioned proximate to a mouthpiece section of the mobile communication device,
wherein when the orientation detection mechanism determines a user's mouth is positioned proximate to the mouthpiece section:
the configuration control mechanism automatically adjusts the first speaker/microphone assembly to activate the speaker and to deactivate the microphone; and
the configuration control mechanism automatically adjusts the second speaker/microphone assembly to activate the microphone and to deactivate the speaker,
and wherein when the orientation detection mechanism determines a user's mouth is positioned proximate to the earpiece section:
the configuration control mechanism automatically adjusts the first speaker/microphone assembly to activate the microphone and to deactivate the speaker, and
the configuration control mechanism automatically adjusts the second speaker/microphone assembly to activate the speaker and to deactivate the microphone.

19. The device of claim 11, wherein the plurality of audio transducers includes a first speaker/microphone assembly positioned proximate to an earpiece section of the mobile communication device and includes a second speaker/microphone assembly positioned proximate to a mouthpiece section of the mobile communication device,
wherein when the orientation detection mechanism determines the device is positioned so that the earpiece section and the mouthpiece section are approximately horizontal to each other:
the configuration control mechanism automatically adjusts the first speaker/microphone assembly to activate the speaker; and
the configuration control mechanism automatically adjusts the second speaker/microphone assembly to activate the speaker.

20. The device claim 11, wherein the plurality of audio transducers includes a first speaker/microphone assembly positioned on a front of the mobile communication device and includes a second speaker/microphone assembly positioned on a back of the mobile communication device, wherein when the orientation detection mechanism determines a user's mouth faces the front of the mobile communication device:
the configuration control mechanism automatically adjusts the first speaker/microphone assembly to activate the speaker and the microphone; and
the configuration control mechanism automatically adjusts the second speaker-microphone assembly to deactivate the speaker,
and wherein when the orientation detection mechanism determines a user's mouth faces the back of the mobile communication device:
the configuration control mechanism automatically adjusts the first speaker/microphone assembly to deactivate the speaker; and
the configuration control mechanism automatically adjusts the second speaker/microphone assembly to activate the speaker and the microphone.
